(19) United States
(12) Patent Application Publication
(10) Pub. No.: US 2018/0043380 A1
(43) Pub. Date: Feb. 15, 2018

(54) Re-Orientable Spray Foam Gun Nozzles

(71) Applicant: ICP ADHESIVES AND SEALANTS, INC., Norton, OH (US)

(72) Inventors: Stefan K. Gantenbein, Medina, OH (US); Mojgan Cline, Copley, OH (US); Krzysztof P. Miedza, Bay Village, OH (US); Scott E. Mizer, Cleveland, OH (US); Brian T. Milliff, Cleveland, OH (US); Michael J. Maczuzak, Bratenahl, OH (US)

(73) Assignee: ICP ADHESIVES AND SEALANTS, INC., Norton, OH (US)

(21) Appl. No.: 15/232,107

(22) Filed: Aug. 9, 2016

(51) Int. Cl. B05B 7/04; G01K 11/16; B05B 12/00; B05B 7/00; B05B 1/02; B05B 7/02

(52) U.S. Cl. CPC B05B 7/0408; B05B 1/02; B05B 7/025; B05B 12/002; B05B 7/0025; G01K 11/16

(57) ABSTRACT

The invention pertains to a plastic spray gun nozzle having an orientable spray pattern achieved by rotational movement of the repositionable plastic nozzle.

### TECHNICAL FIELD

The invention described herein pertains generally to spray foam gun nozzles.

### BACKGROUND OF THE INVENTION

This invention is particularly suited for in-situ applications of liquid chemicals mixed and dispensed as a spray or a foam and more specifically, to in-situ application of polyurethane foam or froth and optionally, the measurement of the temperature of the chemicals used therewith. In-situ applications for polyurethane foam have continued to increase in recent years extending the application of polyurethane foam beyond its traditional uses in the packaging, insulation and molding fields. For example, polyurethane foam is being used with increasing frequency as a sealant in the building trades for sealing spaces between windows and door frames and the like and as an adhesive for gluing flooring, roof tiles, and the like.

Polyurethane foam for in-situ applications is typically supplied as a “one-component” froth foam or a “two-component” froth foam in portable containers hand carried and dispensed by the operator through either a valve or a gun. However, the chemical reactions producing the polyurethane froth foam in a “one-component” polyurethane foam is significantly different than the chemical reactions producing a polyurethane froth foam in a “two-component” polyurethane foam. Because the reactions are different, the dispensing of the chemicals for a two-component polyurethane foam involves different and additional concepts and concerns than that present in the dispensing apparatus for a “one-component” polyurethane froth foam.

A “one-component” foam generally means that both the resin and the isocyanate used in the foam formulation are supplied in a single pressurized container and dispensed from the container through a valve or a gun attached to the container. When the chemicals leave the valve, a reaction with moisture in the air produces a polyurethane froth or foam. Thus, the design concerns related to an apparatus for dispensing one-component polyurethane foam essentially concerns the operating characteristics of how the one-component polyurethane foam is throttled or metered from the pressurized container. While one-component guns can variably meter the polyurethane froth, they are typically used in caulk/glue applications where an adhesive or caulk bead is determined by the nozzle configuration. Post drip is a major concern in such applications as well as the dispensing gun not clogging because of reaction of the one component formulation with air (moisture) within the gun. To address or at least partially address such problems, a needle valve seat is typically applied as close to the dispensing point by a metering rod arrangement which can be pulled back for cleaning. While metering can occur at the needle valve seat, the seat is primarily for shut-off to prevent post drip; and depending on gun dimensioning, metering may principally occur at the gun opening.

In contrast, a “two-component” froth foam means that one principal foam component is supplied in one pressurized container, typically the “A” container (i.e., polymeric isocyanate, fluorocarbons, etc.) while the other principal foam component is supplied in a second pressurized container, typically the “B” container (i.e., polyols, catalysts, flame retardants, fluorocarbons, etc.).

In a two-component polyurethane foam, the “A” and “B” components form the foam or froth, when they are mixed in the gun. Of course, chemical reactions with moisture in the air will also occur with a two-component polyurethane foam after dispensing, but the principal reaction forming the polyurethane foam occurs when the “A” and “B” components are mixed, or contact one another in the dispensing gun. The dispensing apparatus for a two-component polyurethane foam application has to thus address not only the metering design concerns present in a one-component dispensing apparatus, but also the mixing requirements of a two-component polyurethane foam.

Further, a “frothing” characteristic of the foam (foam assumes consistency resembling shaving cream) is enhanced by the fluorocarbon (or similar) component, which is present in the “A” and “B” components. This fluorocarbon component is a compressed gas which exits in its liquid state under pressure and changes to it gaseous state when the liquid is dispensed into a lower pressure ambient environment, such as when the liquid components exit the gun and enter the nozzle.

While polyurethane foam is well known, the formulation varies considerably depending on application. In particular, while the polyols and isocyanates are typically kept separate in the “B” and “A” containers, other chemicals in the formulation may be placed in either container with the result that the weight or viscosity of the liquids in each container varies as well as the ratios at which the “A” and “B” components are to be mixed. In the dispensing gun applications which relate to this invention, the “A” and “B” formulations are such that the mixing ratios are generally kept equal so that the “A” and “B” containers are the same size. However, the weight, more importantly the viscosity, of the liquids in the containers invariably vary from one another. To adjust for viscosity variation between “A” and “B” chemical formulations, the “A” and “B” containers are charged (typically with an inert gas,) at different pressures to achieve equal flow rates. The metering valves in a two-component gun, therefore, have to meter different liquids at different pressures at a precise ratio under varying flow rates. For this reason (among others), some dispensing guns have a design where each metering rod/valve is separately adjustable against a separate spring to compensate not only for ratio variations in different formulations but also viscosity variations between the components. The typical two-component dispensing gun in use today can be viewed as two separate one-component dispensing guns in a common housing discharging their components into a mixing chamber or nozzle. In practice, often the gun operator adjusts the ratio settings to improve gun “performance” with poor results. To counteract this adverse result, the ratio adjustment then has to be “hidden” within the gun, or the design has to be such that the ratio setting is “fixed” in the gun for specific formulations. The gun cost is increased in either event and “fixing” the ratio setting to a specific formulation prevents interchangeability of the dispensing gun.

Besides the ratio control which distinguishes two-component dispensing guns from one-component dispensing guns, a concern which affects all two-component gun designs (not present in one-component dispensing guns) is known in the trade as “cross-over”. Generally, “cross-over” means that one of the components of the foam (“A” or “B”) has crossed over into the dispensing mechanism in the dispensing gun for the other component (“B” or “A”). Cross-over may occur when the pressure variation between the “A” and “B” cylinders becomes significant. Variation can become significant when the foam formulation initially calls for the “A” and “B” containers to be at high differential charge pressures and the containers have discharged a majority of their components. The containers are accumulators which inherently vary the pressure as the contents of the container are used. To overcome this problem, it is known to equip the guns with conventional one-way valves, such as a poppet valve (or other similarly acting device). While necessary, the dispensing gun's cost is increased.

Somewhat related to cross-over and affecting the operation of a two-component gun is the design of the nozzle. The nozzle is a throw away item detachably mounted to the gun nose. Nozzle design is important for cross-over and metering considerations in that the nozzle directs the “A” and “B” components to a static mixer in the gun.

A still further characteristic distinguishing two-component from one-component gun designs resides in the clogging tendencies of two-component guns. Because the foam foaming reaction commences when the “A” and “B” components contact one another, it is clear that, once the gun is used, the static mixer will clog with polyurethane foam or froth formed within the mixer. This is why the nozzles, which contain the static mixer, are designed as throw away items. In practice, the foam does not instantaneously form within the nozzle upon cessation of metering to the point where the nozzles have to be discarded. Some time must elapse. This is a function of the formulation itself, the design of the static mixer and, all things being equal, the design of the nozzle.

The dispensing gun of the present invention is particularly suited for use in two-component polyurethane foam “kits” typically sold to the building or construction trade. In one instance, the kit contains two pressurized “A” and “B” cylinders of about 7.5 inches in diameter which are pressurized anywhere between 130-250 psi, a pair of hoses for connection to the cylinders and a dispensing gun, all of which are packaged in a container constructed to house and carry the components to the site where the foam is to be applied. When the chemicals in the “A” and “B” containers are depleted, the kit is sometimes discarded or the containers can be recycled. The dispensing gun may or may not be replaced. Since the dispensing gun is included in the kit, kit cost considerations dictate that the dispensing gun be relatively inexpensive. Typically, the dispensing gun is made from plastic with minimal usage of machined parts.

The dispensing guns cited and to which this invention relates are additionally characterized and distinguished from other types of multi-component dispensing guns in that they are, “airless” and typically do not contain provisions for cleaning the gun. That is, a number of dispensing or metering guns or apparatus, particularly those used in high volume foam applications, are equipped or provided with a means or mechanism to introduce air or a solvent for cleaning or clearing the passages in the gun. The use of the term “airless” as used in this patent and the claims hereof means that the dispensing apparatus is not provided with an external, cleaning or purging mechanism.

While the two-component dispensing guns discussed above function in a commercially acceptable manner, it is becoming increasingly clear as the number of in-situ applications for polyurethane foam increase, that the range or the ability of the dispensing gun to function for all such applications has to be improved. As a general example, the dispensing gun design has to be able to throttle or meter a fine bead of polyurethane froth in a sealant application where the kit is sold to seal spaces around window frames, door frames, and the like in the building trade. In contrast, where the kit is sold to form insulation, an ability to meter or flow a high volume flow of chemicals is required. Still yet, in an adhesive application, liquid spray patterns of various widths and thickness are required. While the “A” and “B” components for each of these applications are specially formulated and differ from one another, one dispensing gun for all such applications involving different formulations of the chemicals is needed.

At least one recurring quality issue facing the disposable polyurethane foam kit industry is the inability of end-users to effectively assess the core chemical temperature of the liquid and gas contents contained therein. Two important functions are often negatively impacted: achievement of maximum foam kit yield on the job site, and proper chemical cure of the “A” & “B” components.

Maximum yield is highly desired by purchasers of polyurethane foam kit products. If the chemicals are too cold for optimum use, the “B”-side viscosity increases, which in turn distorts the 1:1 ratio (by weight) required for proper yield. Lower-than-advertised yields carry significant economical consequences for the contractor.

Proper chemical cure (on-ratio ˜1:1) is also critical to achieving maximum physical properties. It ensures that the cured foam meets building code specifications, e.g. fire ratings. In addition, a complete, on-ratio cure is critical for the health and safety of foam kit operators and building occupants. Again, cold chemical temperatures (below recommended) can create off-ratio foam, with the resulting incomplete chemical cure.

At least one important variable impacting the above issues is the core chemical temperature of the liquid/gas contents of the foam kit. The core chemical temperature of a kit before use must meet the manufacturer's recommended temperature, usually ˜75° F.-85° F., in order to meet the objectives of maximum yield and proper (complete) chemical cure. However, end-users typically do not condition the kits long enough at the recommended temperature. For example, kits stored in an unconditioned warehouse or insulation truck in the winter months may have a core chemical temperature of only ˜40° F. If dispensed without being conditioned for a sufficient amount of time, the result is foam of very poor physical quality and appearance. Also, improper chemical cure will most likely occur (unbalanced ratio of “A” to “B” chemical, which is typically 1:1 by weight). This “off-ratio” foam becomes a liability for the reasons mentioned above. It can take up to 48 hours to condition cylinders to the recommended chemical temperature, a recommendation often ignored by end-users.

The industry has long searched for an effective, economical way to allow end-users to gauge the core chemical temperature of a kit with a reasonable degree of qualitative accuracy before applying the foam. This invention utilizes thermochromism in both the nozzle and the hoses associated with the “A” and “B” chemicals to determine when the temperature of the chemicals falls within the acceptable use range, based upon the color change of the nozzle or hose due to a change in temperature of the flowing chemical.

Further, certain Prior Art nozzles are capable of dispensing or spraying foam in a straight line pattern. These nozzles include opposed “lips” that are generally fixed in a manner to produce either a horizontal or vertical spray pattern. In order to change the direction or configuration of the spray pattern, a user is required to twist or angle the entire dispensing gun. This can require the user to hold the dispensing gun in uncomfortable positions or at awkward angles in order to orient the straight line pattern of the dispensed foam in the desired direction. This invention overcomes many of the deficiencies of the Prior Art by a unique arrangement of mating channels and raised sections either on the spray gun housing or the removable nozzle.

Further limitations and disadvantages of conventional, traditional, and proposed approaches will become apparent to one of skill in the art, through comparison of such systems and methods with certain embodiments the claimed invention as set forth in the remainder of the present application with reference to the drawings.

### SUMMARY OF THE INVENTION

In accordance with the present invention, a plastic spray gun nozzle is described in which the foam spray pattern is continuously orientable by changing the position of the attached nozzle by rotational movement of the attached nozzle. In some embodiments, the foam spray pattern is continuously orientable by changing the position of a tip of the nozzle.

The plastic spray gun nozzle comprises a tapered elongated cylindrical bore extending along a longitudinal axis. The cylindrical bore has an expanded cylindrical entrance collar at an ingress end and an opposed egress exit end having a pair of divergent opposed lips at the egress exit end. The entrance collar has an interior and an exterior. The nozzle entrance collar is in at least partial rotational mating engagement with an exterior of a front portion of a housing of the spray gun. The at least partial rotational mating engagement involves one of: (a) at least one depressed channel extending at least partially around the exterior circumference of the front portion of the housing of the spray gun and at least one raised projection extending at least partially around the interior circumference of the nozzle entrance collar (e.g. the embodiment shown in FIGS. 3, 4, & 8); and (b) at least one depressed channel extending at least partially around the interior circumference of the nozzle entrance collar and at least one raised projection extending at least partially around the exterior circumference of the front portion of the housing of the spray gun (e.g. the embodiment shown in FIGS. 5, 6, & 9). The plastic spray gun nozzle dispenses a pressurized polyurethane foam or a polyurethane froth.

In the above embodiment, the rotational position of the nozzle can be continuously adjustable while mated with the front portion of the housing of the spray gun. Alternatively, the rotational position of the nozzle can be continuously adjustable within a restricted range defined by the at least one depressed channel while mated with the front portion of the housing of the spray gun.

In another embodiment of the invention, the plastic spray gun nozzle comprises a tapered elongated cylindrical bore extending along a longitudinal axis. The cylindrical bore has an expanded cylindrical entrance collar at an ingress end and an opposed egress exit end. The entrance collar has an interior and an exterior. The nozzle entrance collar is in a mating engagement with a front portion of a housing of a spray gun. A further element of the nozzle is a tip comprising a pair of divergent opposed lips at a first end and a connecting collar at a second end. The connecting collar is in at least partial rotational mating engagement with the egress exit end of the nozzle. The at least partial rotational mating engagement involves one of: (a) at least one depressed channel extending at least partially around the exterior circumference of the egress exit end of the nozzle and at least one raised projection extending at least partially around the interior circumference of the tip connecting collar (e.g. the embodiments shown in FIGS. 7 & 10); (b) at least one depressed channel extending at least partially around the interior circumference of the tip connecting collar and at least one raised projection extending at least partially around the exterior circumference of the egress exit end of the nozzle (e.g. the embodiment 110 shown in FIG. 7); (c) at least one depressed channel extending at least partially around the interior circumference of the egress exit end of the nozzle and at least one raised projection extending at least partially around the exterior circumference of the tip connecting collar which has a pair of notches (e.g. the embodiment 120 shown in FIG. 7); and (d) at least one depressed channel extending at least partially around the exterior circumference of the tip connecting collar, which has a pair of notches, and at least one raised projection extending at least partially around the interior circumference of the egress exit end of the nozzle (e.g. the embodiment shown in FIG. 11). The plastic spray gun nozzle dispenses a pressurized polyurethane foam or a polyurethane froth.

In the above embodiment, the rotational position of the tip can be continuously adjustable while mated with the egress exit end of the nozzle. Alternatively, the rotational position of the tip can be continuously adjustable within a restricted range defined by the at least one depressed channel while mated with the egress exit end of the nozzle.

In some embodiments, the restricted range is limited to approximately 180°. In other embodiments, the restricted range is limited to less than 180°. In some embodiments, the raised projection can be a ridge or a knob. The entrance collar exterior can have at least one pair of longitudinally extending raised ridges along at least a portion of an exterior surface of the entrance collar.

In certain embodiments, the spray gun has a removable plastic spray nozzle affixed to a front of the housing, the plastic spray nozzle comprising at least one thermochromic material disposed within or affixed thereupon the plastic nozzle. In further embodiments, the thermochromic material is affixed upon the plastic nozzle by a label containing the thermochromic material. The at least one thermochromic material is preferably a liquid crystal or a leuco dye. Often, at least two thermochromic materials are disposed within or thereupon said nozzle, each of the at least two thermochromic materials effecting a color change at a different temperature. In yet another aspect of the invention, at least three thermochromic materials are disposed within or thereupon the nozzle, each of the thermochromic materials effecting a color change at a different temperature.

In certain embodiments, the thermochromic material changes color by measuring the temperature of either the flow of pressurized chemicals or flow of synthesized froth foam or both egressing through said plastic nozzle to illustrate to the end-user of the spray gun if the pressurized chemicals and propellant used to prepare the polyurethane foam or the polyurethane froth are at a minimum temperature for proper chemical cure of the “A” and “B” chemicals. The propellant comprises a fluorocarbon and an inert gas in which the propellant enters into the nozzle as a liquid component under the pressure of between approximately 130-250 psi and changes to a gaseous state component during travel through the nozzle and egresses therefrom into the environment with turbulent flow between the liquid components, gaseous components and synthesized froth foam.

### BRIEF DESCRIPTION OF THE DRAWINGS

The invention may take physical form in certain parts and arrangements of parts, a preferred embodiment of which will be described in detail in the specification and illustrated in the accompanying drawing which form a part hereof, and wherein:

FIG. 1 is a perspective view of the nozzle of the present invention mated with a dispensing gun;

FIG. 2 is a side view of the tip of the nozzle, displaying the divergent lips;

FIG. 3 is a perspective view of the nozzle of the present invention with a spray gun having a depressed channel extending substantially around the circumference of the front portion of the housing of the spray gun;

FIG. 4 is a perspective view displaying the interior of the entrance collar of one embodiment of the nozzle of the present invention;

FIG. 5 is a perspective view of the nozzle of the present invention with a spray gun having raised protrusions on the front portion of the housing of the spray gun;

FIG. 6 is a perspective view displaying the interior of the entrance collar of another embodiment of the nozzle of the present invention;

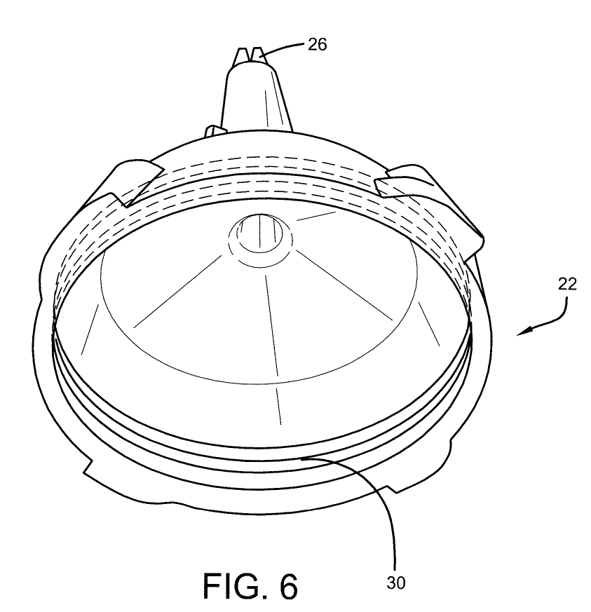

FIG. 7 is a perspective view displaying a spray gun, a nozzle, and two embodiments of a reorientable tip;

FIG. 8 is a perspective view of the nozzle of the present invention with a spray gun having depressed channels extending around a portion of the circumference of the front portion of the housing of the spray gun;

FIG. 9 is a perspective view displaying the interior of the entrance collar of another embodiment of the nozzle of the present invention;

FIG. 10 is a perspective view displaying a spray gun, a nozzle, and two embodiments of a reorientable tip;

FIG. 11 is a perspective view displaying a spray gun, a nozzle, and another embodiment of a reorientable tip; and

FIG. 12 is a perspective view displaying a color-changing label affixed to the exterior of the nozzle.

### DETAILED DESCRIPTION OF THE INVENTION

The best mode for carrying out the invention will now be described for the purposes of illustrating the best mode known to the applicant at the time of the filing of this patent application. The examples and figures are illustrative only and not meant to limit the invention, which is measured by the scope and spirit of the claims.

For consistency in terminology, when describing the plastic spray gun nozzle 20 or the spray gun 50, “longitudinal” will refer to the direction of the dispensing gun along the long axis of dispensing passage; “transverse” will refer to the direction perpendicular to a longitudinal axis. “Protrusion” can refer to at least a raised ridge, knob, or thread.

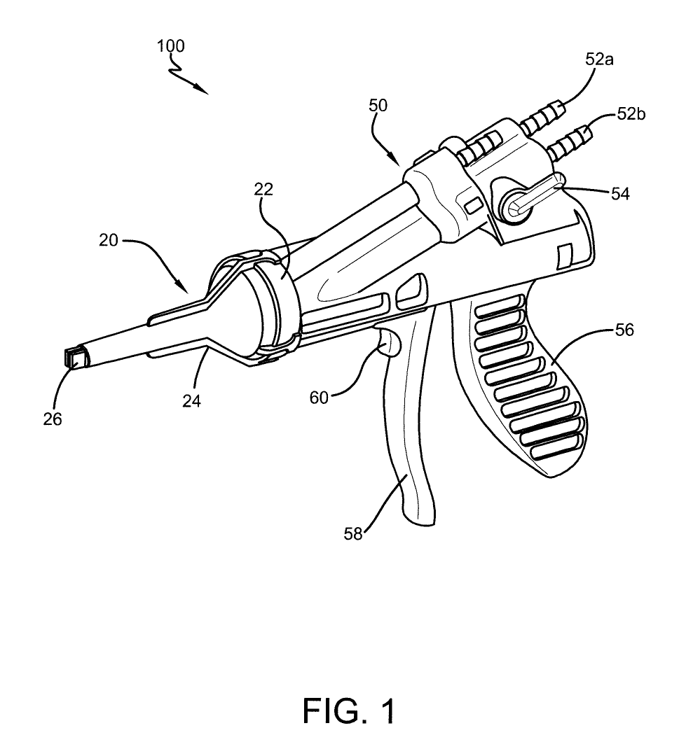

The invention relates to, as shown in the perspective view in FIG. 1, a plastic spray gun nozzle 20 which can be used in dispensing a pressurized polyurethane foam or a polyurethane froth. As displayed by mated assembly 100, nozzle 20 removeably mates with an exterior of front portion 62 of a housing of spray gun body 50. As illustrated, spray gun 50 has a pair of upwardly canting hose openings 52a, 52b in communication with removable nozzle 20. Safety lock 60 is pivotally positioned within dispensing trigger 58 which is positioned before rearward-sloping curvilinear handle 56. Safety lock 60 is accessed and controlled typically via index finger control by the user. In one aspect of the invention, “snap-on” nozzle 20 is a temperature sensitive nozzle in which the nozzle changes color upon sensing the temperature of the dispensed chemicals, thereby permitting the user to visually see if the chemicals are being dispensed at the proper temperature, which at least in part, governs the applied A/B ratio. The dispensing gun is further provided with high/low or on/off output control lever 54 for further control by an operator. When used for high/low flow control, different diametered channels are bored into a transverse shaft of control lever 54.

In one embodiment, nozzle 20 is molded from an ABS (Acrylonitrile-Butadiene-Styrene) plastic. However, the nozzle may be constructed of any rigid material using sound engineering judgment. Nozzle 20 comprises a tapered elongated cylindrical bore extending along a longitudinal axis, the cylindrical bore having an expanded cylindrical entrance collar 22 at an ingress end and an opposed egress exit end having a pair of divergent opposed lips 26. Entrance collar 22 exterior can optionally include at least one pair of longitudinally extending raised ridges 24 along at least a portion of an exterior surface of the entrance collar. Raised ridges 24 create a gripping surface, making it easier for a user to twist nozzle 20. In one embodiment illustrated in FIG. 1, raised ridges 24 extend longitudinally onto the tapered section of the nozzle 20. Nozzle 20 is designed to removeably mate with front portion 62 of the housing of spray gun 50 in different rotational positions. This re-orienting feature allows the operator of a foam dispensing gun to modify the angle of the foam's spray pattern without needing to change the angle at which the user holds the spray gun. Rather than holding the gun at awkward angles to achieve a specific spray pattern, a user of spray gun 50 can simply twist the gun's nozzle 20 while mated with front portion 62 of the housing of spray gun 50 and continue to spray holding the gun in the same orientation, yet achieve a different spray pattern.

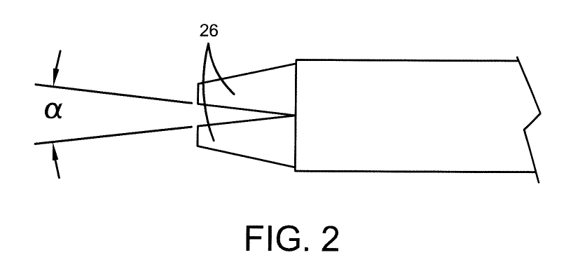

The tip of the nozzle 20 has a pair of flared or divergent lips 26 that meet to create a triangular notch near the base of the tip. The notch at the base of the tip of the nozzle 20 in a most preferred embodiment is triangular in shape to create the desired spray pattern. The lips 26 diverge at an angle α between the divergent lips 26, shown in FIG. 2, preferably 2°-55°, inclusive, and more preferably an angle of 5°-25°, inclusive. A gap exists between the end of the lips 26 of the nozzle 20 where the spray foam exits the nozzle 20.

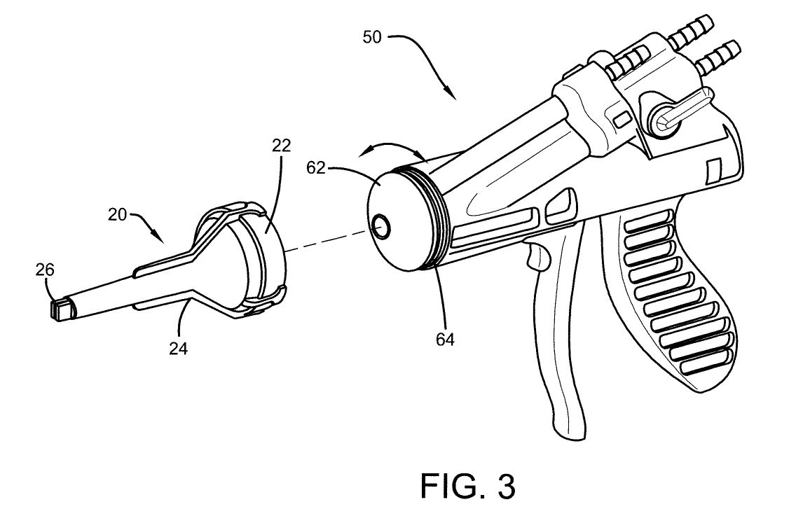

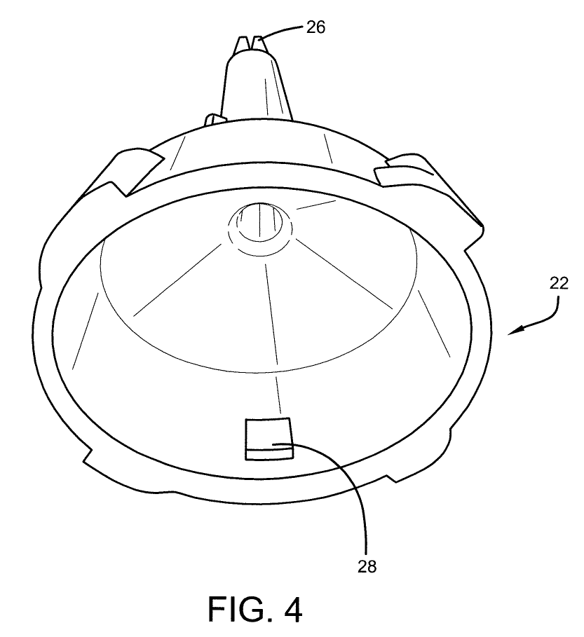

As better illustrated in FIG. 3, the exterior of front portion 62 of the housing of spray gun 50 has at least one depressed channel 64 extending substantially around the circumference of front portion 62 of the housing of spray gun 50. In certain embodiments, depressed channel 64 extends completely around (360° around) the circumference of front portion 62. In other embodiments, depressed channel 64 extends less than completely around the circumference of front portion 62. As depicted in FIG. 4, the interior of the nozzle's 20 entrance collar 22 has at least one protrusion 28. The at least one protrusion 28 can be matingly engaged with depressed channel 64 on the exterior of front portion 62 of the housing of spray gun 50 so that nozzle 20 is secured to front portion 62 of the housing of spray gun 50. Once secured to front portion 62, nozzle 20 can be rotated freely by a user. This free rotation of nozzle 20 allows for continuous adjustment of the rotational position of nozzle 20. The benefit of this ability is that continuous adjustment of the rotational position of nozzle 20 allows the user to implement different angles of the foam spray pattern created by divergent lips 26. The spray pattern can be adjusted to a vertical spray pattern, a horizontal spray pattern, or a spray pattern having any angle therebetween. While at least one protrusion 28 is illustrated, it is recognized that a series of protrusions may be employed. It is further recognized that a mating ring and depressed channel 64 may be employed to connect nozzle 20 to spray gun 50.

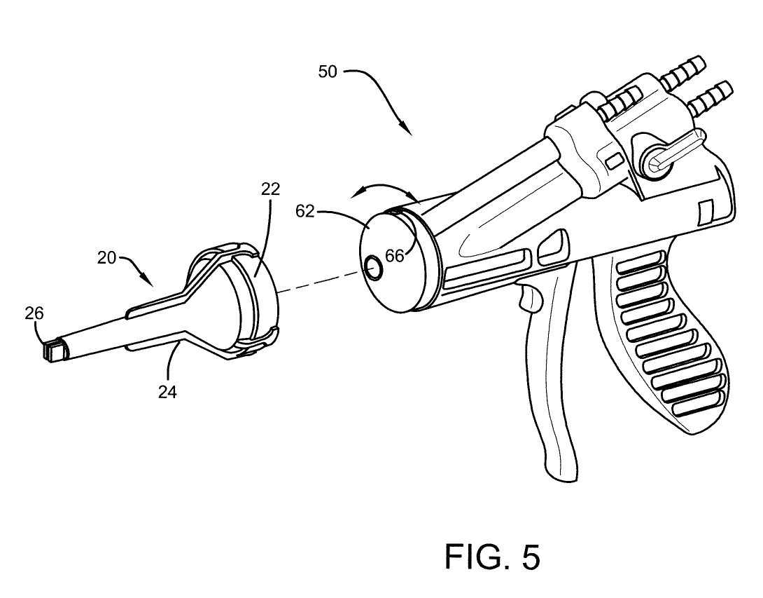

It should be appreciated that the mating structure locations can be interchanged. For example, FIGS. 5 & 6 depict another embodiment in which the exterior of front portion 62 has at least one protrusion 66. Nozzle's 20 entrance collar interior has at least one depressed channel 30 extending substantially around the circumference of expanded cylindrical entrance collar 22 interior. In certain embodiments, depressed channel 30 extends completely around (360° around) the circumference of expanded cylindrical entrance collar 22 interior. In other embodiments, depressed channel 30 extends slightly less than completely around the circumference of expanded cylindrical entrance collar 22 interior. The at least one protrusion 66 on the exterior of the front portion 62 can be matingly engaged with the depressed channel 30 of the interior of the expanded cylindrical entrance collar 22 so that nozzle 20 is secured to front portion 62 of the housing of spray gun 50. Once secured to front portion 62, nozzle 20 can be rotated freely by a user. This free rotation of nozzle 20 allows for continuous adjustment of the rotational position of nozzle 20 similar to the above embodiment.

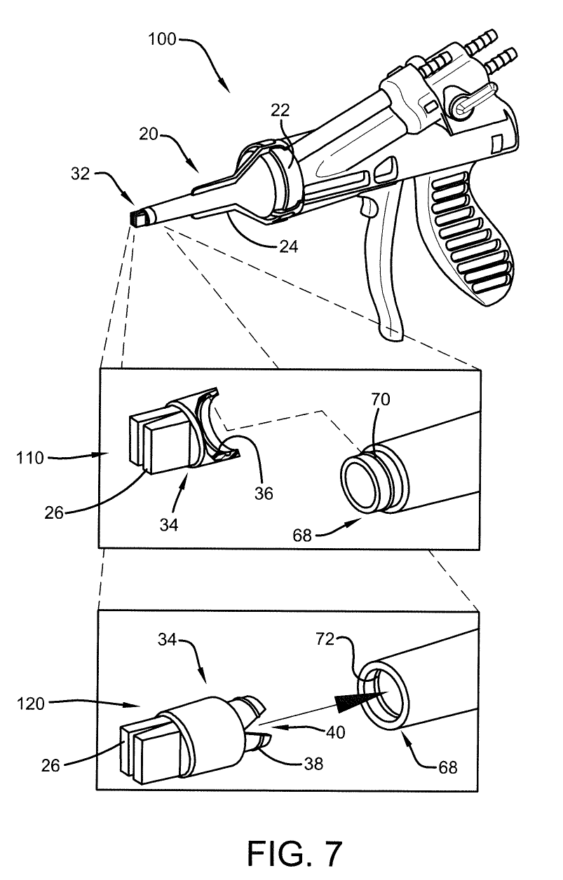

FIG. 7 depicts further embodiments of the present invention. In these embodiments, nozzle 20 can have any of the same structures as previously described. Nozzle 20 can mate with front portion 62 of spray gun 50 in any manner previously described or in any other manner using sound engineering judgment. Tip 32 is removeably mated with an egress exit end 68 of nozzle 20. Tip 32 has a pair of divergent opposed lips 26 at a first end and a connecting collar 34 at a second end. In a first embodiment 110, egress exit end 68 of nozzle 20 has a first raised ridge 70 or a depressed channel 72, wherein the first raised ridge 70 or depressed channel 72 extends substantially around a circumference of an exterior of the egress exit end 68. Connecting collar 34 of tip 32 has a second raised ridge 38 or a depressed channel 36 extending substantially around the circumference of the interior of connecting collar 34. First raised ridge 70 or depressed channel 72 is matingly engaged with the second raised ridge 38 or depressed channel 36 so that the tip is secured to egress end 68 of the cylindrical bore. It should be appreciated that the raised ridges (70, 38) and depressed channels (72, 36) can extend around the entire circumference of its respective surface or around a smaller portion of its respective surface in a manner that creates restricted rotation of the tip 32.

In a second embodiment 120, the egress exit end 68 of nozzle 20 has a first raised ridge 70 or a depressed channel 72, wherein the first raised ridge 70 or depressed channel 72 extends substantially around a circumference of an interior of the egress exit end 68. Connecting collar 34 of tip 32 has a pair of notches 40 and a second raised ridge 38 or a depressed channel 36 extending substantially around the circumference of the exterior of connecting collar 34. First raised ridge 70 or depressed channel 72 is matingly engaged with the second raised ridge 38 or depressed channel 36 so that the tip is secured to egress end 68 of the cylindrical bore. Notches 40 allow connecting collar 34 to be slightly compressed, allowing connecting collar 34 to fit into the interior of egress exit end 68.

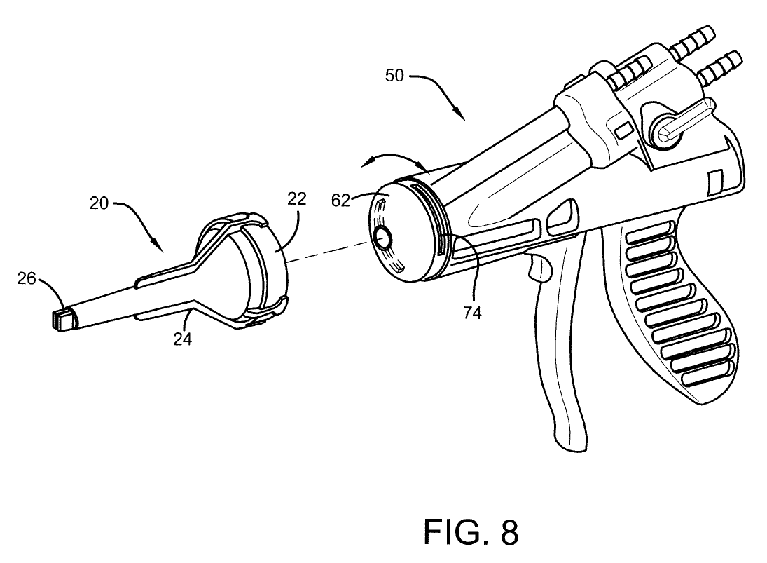

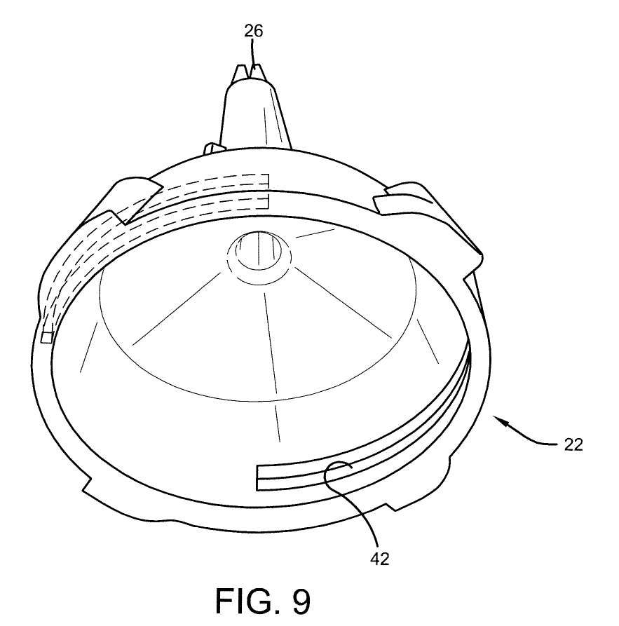

Looking now to FIG. 8, embodiments of the present invention can have at least one depressed channel 74 in front portion 62 of spray gun 50, the channel 74 extends only partially around circumference of the exterior of front portion 62. For example, in certain embodiments, depressed channel 74 extends along less than 180° of the circumference of the exterior of front portion 62. In other embodiments, depressed channel 74 extends along 90° of the circumference of the exterior of front portion 62. This feature creates a restricted rotation of nozzle 20. Rotational position of nozzle 20 in this embodiment is continuously adjustable by twisting within the restricted range of rotation defined by depressed channels 74. The termination of depressed channels 74 on either end acts as a detent. The corresponding expanded cylindrical entrance collar 22 interior has protrusions 28 as shown in FIG. 4. It should be appreciated that the mating connections can be interchanged. For example, the front portion 62 can have the protrusions 66 as shown in FIG. 5 while the interior of expanded cylindrical entrance collar 22 can have depressed channels 42 extending along a portion of the circumference of the interior of expanded cylindrical entrance collar 22 as shown in FIG. 9.

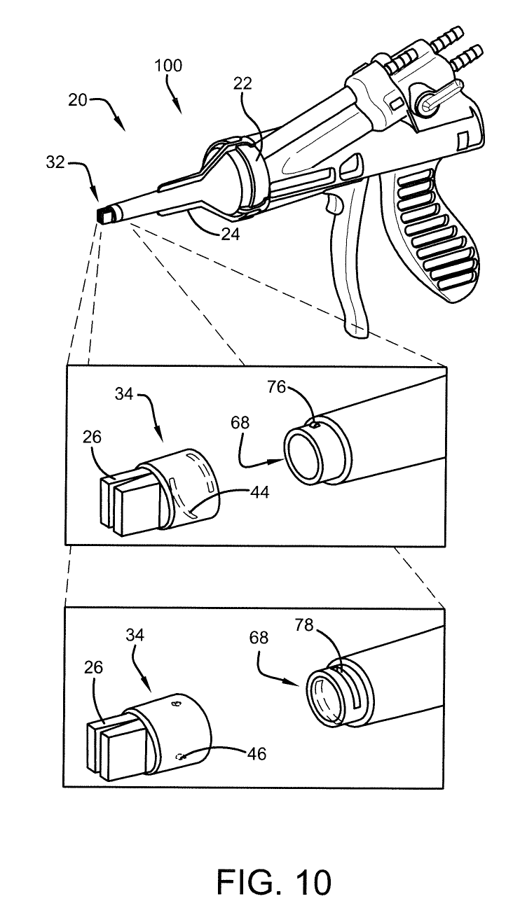

FIG. 10 shows additional embodiments of the present invention. These embodiments have a similar tip 32 as described in reference FIG. 7. In one embodiment, connecting collar 34 of tip 32 has a pair of depressed channels 44 that each extend along a portion of the interior circumference of connecting collar 34. For example, each depressed channel 44 of the pair may extend about less than 180° along the inner circumference of the connecting collar 34. In another example, each depressed channel 44 of the pair may extend about 90° along the inner circumference of the connecting collar 34. These depressed channels 44 matingly engage with a pair of raised protrusions 76 located on the exterior of egress exit end 68 of nozzle 20 so that tip 32 is secured to egress end 68 of the cylindrical bore. Alternatively, egress exit end 68 of nozzle 20 can have the pair of depressed channels 78 extending along a portion of the exterior perimeter of the egress exit end 68 of the nozzle 20 while the interior of the connecting collar 34 has the raised protrusions 46 that matingly engage with the pair of depressed channels 78 so that the tip 32 is secured to the egress end 68 of the cylindrical bore. In these embodiments, the pair of channels 78 create restricted rotation of the tip 32. The rotational position of tip 32 is continuously adjustable by twisting within the restricted rotational range defined by depressed channels 78. The termination of depressed channels 78 on either end acts as a detent.

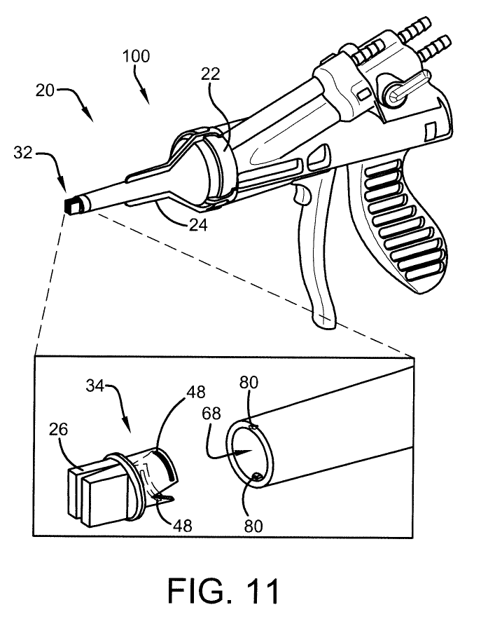

FIG. 11 depicts another embodiment of the present invention. In this embodiment, connecting collar 34 of tip 32 has a pair of depressed channels 48 that each extend along a portion of the exterior circumference of connecting collar 34. For example, each depressed channel 48 of the pair may extend less than 180° along the outer circumference of the connecting collar 34. In another example, each depressed channel 48 of the pair may extend about 90° along the outer circumference of the connecting collar 34. These depressed channels 48 matingly engage with a pair of raised protrusions 80 located on the interior of egress exit end 68 of nozzle 20 so that tip 32 is secured to egress end 68 of the cylindrical bore. In this embodiment, the pair of channels 48 create restricted rotation of the tip 32. The rotational position of tip 32 is continuously adjustable by twisting within the restricted rotational range defined by depressed channels 48. The termination of depressed channels 48 on either end acts as a detent.

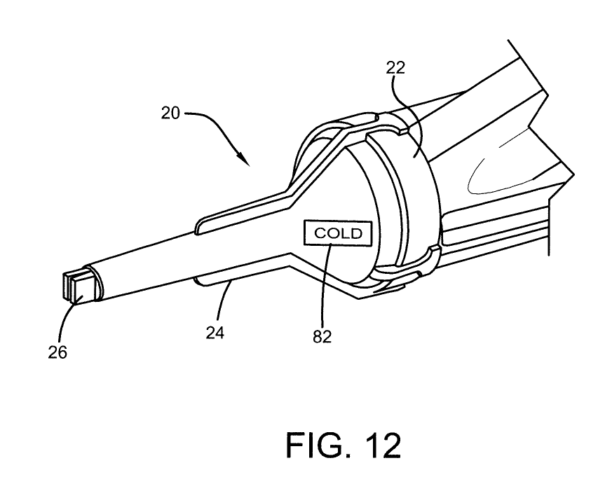

In one additional aspect of the invention, the ability to determine the chemical temperature as the foam or froth enters and/or exits nozzle 20 is effected by having a thermochromic material contained within the plastic used to mold disposable nozzle 20. Turning to FIG. 12, still another approach involves affixing a label 82 either permanently using a permanent adhesive or non-permanently, using a pressure-sensitive adhesive (the label 82 optionally having thermochromic text or thermochromic graphic material printed thereupon) which changes in one instance from colored (below the recommended use temperature, illustrated by the text “Cold” in FIG. 12), to colorless or a different color when the chemicals have transferred a sufficient amount of heat to the nozzle or label 82. While a label is only illustrated in one figure, it is recognized that a label may be affixed to any nozzle illustrated in any of the figures.

Thermochromism is typically implemented via one of two common approaches: liquid crystals and leuco dyes. Liquid crystals are used in precision applications, as their responses can be engineered to accurate temperatures, but their color range is limited by their principle of operation. Leuco dyes allow wider range of colors to be used, but their response temperatures are more difficult to set with accuracy.

Some liquid crystals are capable of displaying different colors at different temperatures. This change is dependent on selective reflection of certain wavelengths by the crystalline structure of the material, as it changes between the low-temperature crystalline phase, through anisotropic chiral or twisted nematic phase, to the high-temperature isotropic liquid phase. Only the nematic mesophase has thermochromic properties. This restricts the effective temperature range of the material.

The twisted nematic phase has the molecules oriented in layers with regularly changing orientation, which gives them periodic spacing. The light passing through the crystal undergoes Bragg diffraction on these layers, and the wavelength with the greatest constructive interference is reflected back, which is perceived as a spectral color. A change in the crystal temperature can result in a change of spacing between the layers and therefore in the reflected wavelength. The color of the thermochromic liquid crystal can therefore continuously range from non-reflective (black) through the spectral colors to black again, depending on the temperature. Typically, the high temperature state will reflect blue-violet, while the low-temperature state will reflect red-orange. Since blue is a shorter wavelength than red, this indicates that the distance of layer spacing is reduced by heating through the liquid-crystal state.

Some such materials are cholesteryl nonanoate or cyanobiphenyls. Liquid crystals used in dyes and inks often come microencapsulated, in the form of suspension. Liquid crystals are used in applications where the color change has to be accurately defined.

Thermochromic dyes are based on mixtures of leuco dyes with suitable other chemicals, displaying a color change (usually between the colorless leuco form and the colored form) in dependence on temperature. The dyes are rarely applied on materials directly; they are usually in the form of microcapsules with the mixture sealed inside. An illustrative example would include microcapsules with crystal violet lactone, weak acid, and a dissociable salt dissolved in dodecanol; when the solvent is solid, the dye exists in its lactone leuco form, while when the solvent melts, the salt dissociates, the pH inside the microcapsule lowers, the dye becomes protonated, its lactone ring opens, and its absorption spectrum shifts drastically, therefore it becomes deeply violet. In this case the apparent thermochromism is in fact halochromism.

The dyes most commonly used are spirolactones, fluorans, spiropyrans, and fulgides. The weak acids include bisphenol A, parabens, 1,2,3-triazole derivates, and 4-hydroxycoumarin and act as proton donors, changing the dye molecule between its leuco form and its protonated colored form; stronger acids would make the change irreversible.

Leuco dyes have less accurate temperature response than liquid crystals. They are suitable for general indicators of approximate temperature. They are usually used in combination with some other pigment, producing a color change between the color of the base pigment and the color of the pigment combined with the color of the non-leuco form of the leuco dye. Organic leuco dyes are available for temperature ranges between about 23° F. (−5° C.) and about 140° F. (60° C.), in wide range of colors. The color change usually happens in about a 5.4° F. (3° C.) interval.

The size of the microcapsules typically ranges between 3-5 μm (over 10 times larger than regular pigment particles), which requires some adjustments to printing and manufacturing processes.

Thermochromic paints use liquid crystals or leuco dye technology. After absorbing a certain amount of light or heat, the crystalline or molecular structure of the pigment reversibly changes in such a way that it absorbs and emits light at a different wavelength than at lower temperatures.

The thermochromic dyes contained either within or affixed upon either the disposable nozzle or hoses may be configured to change the color of the composition in various ways. For example, in one embodiment, once the composition reaches a selected temperature, the composition may change from a base color to a white color or a clear color. In another embodiment, a pigment or dye that does not change color based on temperature may be present for providing a base color. The thermochromic dyes, on the other hand, can be included in order to change the composition from the base color to at least one other color.

In one particular embodiment, the plurality of thermochromic dyes are configured to cause the cleansing composition to change color over a temperature range of at least about 3° C., such as at least about 5° C., once the composition is heated to a selected temperature. For example, multiple thermochromic dyes may be present within the cleansing composition so that the dyes change color as the composition gradually increases in temperature. For instance, in one embodiment, a first thermochromic dye may be present that changes color at a temperature of from about 23° C. to about 28° C. and a second thermochromic dye may be present that changes color at a temperature of from about 27° C. to about 32° C. If desired, a third thermochromic dye may also be present that changes color at a temperature of from about 31° C. to about 36° C. In this manner, the cleansing composition changes color at the selected temperature and then continues to change color in a stepwise manner as the temperature of the composition continues to increase. It should be understood that the above temperature ranges are for exemplary and illustrative purposes only.

Any thermochromic substance that undergoes a color change at the desired temperature may generally be employed in the present disclosure. For example, liquid crystals may be employed as a thermochromic substance in some embodiments. The wavelength of light (“color”) reflected by liquid crystals depends in part on the pitch of the helical structure of the liquid crystal molecules. Because the length of this pitch varies with temperature, the color of the liquid crystals is also a function of temperature. One particular type of liquid crystal that may be used in the present disclosure is a liquid crystal cholesterol derivative. Exemplary liquid crystal cholesterol derivatives may include alkanoic and aralkanoic acid esters of cholesterol, alkyl esters of cholesterol carbonate, cholesterol chloride, cholesterol bromide, cholesterol acetate, cholesterol oleate, cholesterol caprylate, cholesterol oleyl-carbonate, and so forth. Other suitable liquid crystal compositions are possible and contemplated within the scope of the invention.

In addition to liquid crystals, another suitable thermochromic substance that may be employed in the present disclosure is a composition that includes a proton accepting chromogen (“Lewis base”) and a solvent. The melting point of the solvent controls the temperature at which the chromogen will change color. More specifically, at a temperature below the melting point of the solvent, the chromogen generally possesses a first color (e.g., red). When the solvent is heated to its melting temperature, the chromogen may become protonated or deprotonated, thereby resulting in a shift of the absorption maxima. The nature of the color change depends on a variety of factors, including the type of proton-accepting chromogen utilized and the presence of any additional temperature-insensitive chromogens. Regardless, the color change is typically reversible.

Although not required, the proton-accepting chromogen is typically an organic dye, such as a leuco dye. In solution, the protonated form of the leuco dye predominates at acidic pH levels (e.g., pH of about 4 or less). When the solution is made more alkaline through deprotonation, however, a color change occurs. Of course, the position of this equilibrium may be shifted with temperature when other components are present. Suitable and non-limiting examples of leuco dyes for use in the present disclosure may include, for instance, phthalides; phthalanes; substituted phthalides or phthalanes, such as triphenylmethane phthalides, triphenylmethanes, or diphenylmethanes; acyl-leucomethylene blue compounds; fluoranes; indolylphthalides, spiropyranes; cumarins; and so forth. Exemplary fluoranes include, for instance, 3,3′-dimethoxyfluorane, 3,6-dimethoxyfluorane, 3,6-di-butoxyfluorane, 3-chloro-6-phenylamino-flourane, 3-diethylamino-6-dimethylfluorane, 3-diethylamino-6-methyl-7-chlorofluorane, and 3-diethyl-7,8-benzofluorane, 3,3′-bis-(p-dimethyl-aminophenyl)-7-phenylaminofluorane, 3-diethylamino-6-methyl-7-phenylamino-fluorane, 3-diethylamino-7-phenyl-am inofluorane, and 2-anilino-3-methyl-6-diethylamino-fluorane. Likewise, exemplary phthalides include 3,3′,3″-tris(p-dimethylamino-phenyl)phthalide, 3,3′-bis(p-dimethyl-aminophenyl)phthalide, 3,3-bis(p-diethylamino-phenyl)-6-dimethylamino-phthalide, 3-(4-diethylaminophenyl)-3-(1-ethyl-2-methylindol-3-yl)phthalide, and 3-(4-diethylamino-2-methyl)phenyl-3-(1,2-dimethylindol-3-yl)phthalide.

Although any solvent for the thermochromic dye may generally be employed in the present disclosure, it is typically desired that the solvent have a low volatility. For example, the solvent may have a boiling point of about 150° C. or higher, and in some embodiments, from about 170° C. to 280° C. Likewise, the melting temperature of the solvent is also typically from about 25° C. to about 40° C., and in some embodiments, from about 30° C. to about 37° C. Examples of suitable solvents may include saturated or unsaturated alcohols containing about 6 to 30 carbon atoms, such as octyl alcohol, dodecyl alcohol, lauryl alcohol, cetyl alcohol, myristyl alcohol, stearyl alcohol, behenyl alcohol, geraniol, etc.; esters of saturated or unsaturated alcohols containing about 6 to 30 carbon atoms, such as butyl stearate, methyl stearate, lauryl laurate, lauryl stearate, stearyl laurate, methyl myristate, decyl myristate, lauryl myristate, butyl stearate, lauryl palmitate, decyl palmitate, palmitic acid glyceride, etc.; azomethines, such as benzylideneaniline, benzylidenelaurylamide, o-methoxybenzylidene laurylamine, benzylidene p-toluidine, p-cumylbenzylidene, etc.; amides, such as acetamide, stearamide, etc.; and so forth.

The thermochromic composition may also include a proton-donating agent (also referred to as a “color developer”) to facilitate the reversibility of the color change. Such proton-donating agents may include, for instance, phenols, azoles, organic acids, esters of organic acids, and salts of organic acids. Exemplary phenols may include phenylphenol, bisphenol A, cresol, resorcinol, chlorolucinol, b-naphthol, 1,5-dihydroxynaphthalene, pyrocatechol, pyrogallol, trimer of p-chlorophenol-formaldehyde condensate, etc. Exemplary azoles may include benzotriaoles, such as 5-chlorobenzotriazole, 4-laurylaminosulfobenzotriazole, 5-butylbenzotriazole, dibenzotriazole, 2-oxybenzotriazole, 5-ethoxycarbonylbenzotriazole, etc.; imidazoles, such as oxybenzimidazole, etc.; tetrazoles; and so forth. Exemplary organic acids may include aromatic carboxylic acids, such as salicylic acid, methylenebissalicylic acid, resorcylic acid, gallic acid, benzoic acid, p-oxybenzoic acid, pyromellitic acid, b-naphthoic acid, tannic acid, toluic acid, trimellitic acid, phthalic acid, terephthalic acid, anthranilic acid, etc.; aliphatic carboxylic acids, such as stearic acid, 1,2-hydroxystearic acid, tartaric acid, citric acid, oxalic acid, lauric acid, etc.; and so forth. Exemplary esters may include alkyl esters of aromatic carboxylic acids in which the alkyl moiety has 1 to 6 carbon atoms, such as butyl gallate, ethyl p-hydroxybenzoate, methyl salicylate, etc.

The amount of the proton-accepting chromogen employed may generally vary, but is typically from about 2 wt. % to about 20 wt. %, and in some embodiments, from about 5 to about 15 wt. % of the thermochromic substance. Likewise, the proton-donating agent may constitute from about 5 to about 40 wt. %, and in some embodiments, from about 10 wt. % to about 30 wt. % of the thermochromic substance. In addition, the solvent may constitute from about 50 wt. % to about 95 wt. %, and in some embodiments, from about 65 wt. % to about 85 wt. % of the thermochromic composition.

Regardless of the particular thermochromic substance employed, it may be microencapsulated to enhance the stability of the substance during processing. For example, the thermochromic substance may be mixed with a thermosetting resin according to any conventional method, such as interfacial polymerization, in-situ polymerization, etc. The thermosetting resin may include, for example, polyester resins, polyurethane resins, melamine resins, epoxy resins, diallyl phthalate resins, vinylester resins, and so forth. The resulting mixture may then be granulated and optionally coated with a hydrophilic macromolecular compound, such as alginic acid and salts thereof, carrageenan, pectin, gelatin and the like, semisynthetic macromolecular compounds such as methylcellulose, cationized starch, carboxymethylcellulose, carboxymethylated starch, vinyl polymers (e.g., polyvinyl alcohol), polyvinylpyrrolidone, polyacrylic acid, polyacrylamide, maleic acid copolymers, and so forth. The resulting thermochromic microcapsules typically have a size of from about 1 to about 50 micrometers, and in some embodiments, from about 3 to about 15 micrometers. Various other microencapsulation techniques may also be used.

Thermochromic dyes are commercially available from various sources. In one embodiment, for instance, thermochromic dyes marketed by Chromadic creations, Hamilton, Ontario and sold under the trade name SpectraBurst Thermochromic Polypropylene.

The thermochromic dyes can be present in the composition in an amount sufficient to have a visual effect on the color of the composition. The amount or concentration of the dyes can also be increased or decreased depending upon the desired intensity of any color. In general, the thermochromic dyes may be present in the composition in an amount from about 0.01% by weight to about 9% by weight, such as from about 0.1% by weight to about 3% by weight. For instance, in one particular embodiment, the thermochromic dyes may be present in an amount from about 0.3% to about 1.5% by weight.

As described above, thermochromic dyes typically change from a specific color to clear at a certain temperature, e.g., dark blue below 60° F. to transparent or translucent above 60° F. If desired, other pigments or dyes can be added to the composition in order to provide a background color that remains constant independent of the temperature of the composition. By adding other pigments or dyes in combination with the thermochromic dyes to the composition, the thermochromic dyes can provide a color change at certain temperatures rather than just a loss of color should the thermochromic dye become clear. For instance, a non-thermochromic pigment, such as a yellow pigment, may be used in conjunction with a plurality of thermochromic dyes, such as a red dye and a blue dye. When all combined together, the cleansing composition may have a dark color. As the composition is increased in temperature, the red thermochromic dye may turn clear changing the color to a green shade (a combination of yellow and blue). As the temperature further increases, the blue thermochromic dye turns clear causing the composition to turn yellow.

It should be understood, that all different sorts of thermochromic dyes and non-thermochromic pigments and dyes may be combined in order to produce a composition having a desired base color and one that undergoes desired color changes. The color changes, for instance, can be somewhat dramatic and fanciful. For instance, in one embodiment, the composition may change from green to yellow to red.

In an alternative embodiment, however, the composition can contain different thermochromic dyes all having the same color. As the temperature of the composition is increased, however, the shade or intensity of the color can change. For instance, the composition can change from a vibrant blue to a light blue to a clear color.

In addition to the above, it should be understood that many alterations and permutations are possible. Any of a variety of colors and shades can be mixed in order to undergo color changes as a function of temperature.

It should be noted that it is surprising that the color-changing effect is capable of being visualized in the first instance, in that the sequence is that an aerosol (gas and liquid droplet mixture) of “A” and “B” reactants are formed upon entry from the hoses from the “A” and “B” cylinders which upon contact begins the “frothing” process in the synthesis of a foam having the consistency of shaving cream. As is known in the industry, the final crosslinking process which gives the foam some rigidity, is effected after egress from the nozzle tip and upon exposure to moisture in the air as well as coming from typically the “B” cylinder as a reactant.

The heat transfer characteristics of an aerosol “froth” foam are not good. The “froth” would be in contact with the walls of the nozzle for a period of approximately 85-100 milliseconds at a typical flow rate of 50 g/sec. in that most two-component spray systems use 130-250 psi pressure in the hoses which results in the above nozzle residence time. The very short contact time coupled with the large amount of “void” space, which is inherent in the definition of a “froth” foam makes it quite surprising that any type of indication of temperature is possible in the nozzle of a spray foam gun. It is counter-intuitive to believe that any indication of temperature is possible under these conditions. This is all the more remarkable in that foam is used as insulation, and for that very reason, its heat-transfer characteristics are not good.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. In combination, a plastic spray gun nozzle with a spray gun, wherein:
the plastic spray gun nozzle comprises a tapered elongated cylindrical nozzle bore extending along a longitudinal axis, said cylindrical nozzle bore having an expanded cylindrical nozzle entrance collar at an ingress end and an opposed egress exit end having a pair of divergent opposed lips at the egress exit end;
said nozzle entrance collar comprising an interior and an exterior; and
the nozzle entrance collar in at least partial rotational mating engagement with an exterior of a front portion of a housing of the spray gun, the at least partial rotational mating engagement selected from the group consisting of
(a) at least one depressed channel extending at least partially around the exterior circumference of the front portion of the housing of the spray gun and at least one raised projection extending at least partially around the interior circumference of the nozzle entrance collar; and
(b) at least one depressed channel extending at least partially around the interior circumference of the nozzle entrance collar and at least one raised projection extending at least partially around the exterior circumference of the front portion of the housing of the spray gun; and wherein
said plastic spray nozzle dispenses a pressurized polyurethane foam or a polyurethane froth in an oriented spray pattern.

2. The combination of claim 1 wherein a rotational position of the nozzle is continuously adjustable while mated with the front portion of the housing of the spray gun.

3. The combination of claim 1 wherein a rotational position of the nozzle is continuously adjustable within a restricted range defined by the at least one depressed channel while mated with the front portion of the housing of the spray gun.

4. The combination of claim 3 wherein the restricted range is limited to less than 180°.

5. The combination of claim 1 wherein the at least one raised projection is a ridge.

6. The combination of claim 1 wherein the at least one raised projection is a knob.

7. The combination of claim 1 wherein the entrance collar exterior comprises at least one pair of longitudinally extending raised ridges along at least a portion of an exterior surface of the entrance collar.

8. The combination of claim 1 further comprising at least one thermochromic material disposed within or affixed thereupon said plastic spray gun nozzle.

9. The combination of claim 7 wherein said thermochromic material changing color by measuring the temperature of either the flow of pressurized chemicals or flow of synthesized froth foam or both egressing through said plastic nozzle to illustrate to the end-user of the spray gun if the pressurized chemicals and propellant used to prepare the polyurethane foam or the polyurethane froth are at a minimum temperature for proper chemical cure of the “A” and “B” chemicals, the propellant comprising a fluorocarbon and an inert gas in which the propellant enters into the nozzle as a liquid component under the pressure of between approximately 130-250 psi and changes to a gaseous state component during travel through the nozzle and egress therefrom into the environment with turbulent flow between the liquid components, gaseous components and synthesized froth foam.

10. The combination of claim 7 wherein said thermochromic material is affixed upon said plastic nozzle by a label containing said thermochromic material.

11. A plastic spray gun nozzle comprising:
a tapered elongated cylindrical nozzle bore extending along a longitudinal axis, said cylindrical nozzle bore having an expanded cylindrical nozzle entrance collar at an ingress end and an opposed egress exit end;
said nozzle entrance collar comprising an interior and an exterior; and
the nozzle entrance collar in mating engagement with a front portion of a housing of a spray gun;
a tip comprising a pair of divergent opposed lips at a first end and a connecting collar at a second end, the connecting collar in at least partial rotational mating engagement with the egress exit end of the nozzle, the at least partial rotational mating engagement selected from the group consisting of
(a) at least one depressed channel extending at least partially around the exterior circumference of the egress exit end of the nozzle and at least one raised projection extending at least partially around the interior circumference of the tip connecting collar;
(b) at least one depressed channel extending at least partially around the interior circumference of the tip connecting collar and at least one raised projection extending at least partially around the exterior circumference of the egress exit end of the nozzle;
(c) at least one depressed channel extending at least partially around the interior circumference of the egress exit end of the nozzle and at least one raised projection extending at least partially around the exterior circumference of the tip connecting collar, the connecting collar further comprising a pair of notches; and
(d) at least one depressed channel extending at least partially around the exterior circumference of the tip connecting collar and at least one raised projection extending at least partially around the interior circumference of the egress exit end of the nozzle, the connecting collar further comprising a pair of notches; and wherein
said plastic spray nozzle dispenses a pressurized polyurethane foam or a polyurethane froth in an oriented spray pattern.

12. The plastic spray gun nozzle of claim 11 wherein a rotational position of the tip is continuously adjustable while mated with the egress exit end of the nozzle.

13. The plastic spray gun nozzle of claim 11 wherein a rotational position of the tip is continuously adjustable within a restricted range defined by the at least one depressed channel while mated with the egress exit end of the nozzle.

14. The combination of claim 13 wherein the restricted range is limited to less than 180°.

15. The combination of claim 11 wherein the at least one raised projection is a ridge.

16. The combination of claim 11 wherein the at least one raised projection is a knob.

17. The plastic spray gun nozzle of claim 11 wherein the entrance collar exterior comprises at least one pair of longitudinally extending raised ridges along at least a portion of an exterior surface of the entrance collar.

18. The plastic spray gun nozzle of claim 11 further comprising at least one thermochromic material disposed within or affixed thereupon said plastic spray gun nozzle.

19. The plastic spray gun nozzle of claim 17 wherein said thermochromic material changing color by measuring the temperature of either the flow of pressurized chemicals or flow of synthesized froth foam or both egressing through said plastic nozzle to illustrate to the end-user of the spray gun if the pressurized chemicals and propellant used to prepare the polyurethane foam or the polyurethane froth are at a minimum temperature for proper chemical cure of the “A” and “B” chemicals, the propellant comprising a fluorocarbon and an inert gas in which the propellant enters into the nozzle as a liquid component under the pressure of between approximately 130-250 psi and changes to a gaseous state component during travel through the nozzle and egress therefrom into the environment with turbulent flow between the liquid components, gaseous components and synthesized froth foam.

20. The plastic spray gun nozzle of claim 17 wherein said thermochromic material is affixed upon said plastic nozzle by a label containing said thermochromic material.
